(19) United States
(12) Patent Application Publication
(10) Pub. No.: US 2010/0083894 A1
(43) Pub. Date: Apr. 8, 2010

(54) MULTI-COLORED FEATURES FOR INSTRUMENT CLUSTER GAUGES

(75) Inventors: Vyacheslav B. Birman, Auburn Hills, MI (US); Marcus Moll, Langenselbold (DE); Ronald A. Struck, Flushing, MI (US); Werner Eckardt, Rochester, MI (US); Heath D. Zietz, Ortonville, MI (US)

Correspondence Address: CARLSON, GASKEY & OLDS, P.C., 400 WEST MAPLE ROAD, SUITE 350, BIRMINGHAM, MI, 48009, US

(73) Assignee: CONTINENTAL AUTOMOTIVE SYSTEMS US, INC., Auburn Hills, MI (US)

(21) Appl. No.: 12/246,679

(22) Filed: Oct. 7, 2008

(51) Int. Cl. G01D 11/28

(52) U.S. Cl. 116/288

(57) ABSTRACT

An instrument cluster includes a gauge with selectively and visually variable features to communicate vehicle information to a vehicle operator. A border is illuminatable by colored LED assemblies to provide an indication of the range of a vehicle operating condition. A pointer assembly is also selectively illuminatable to provide a visual reference of a specific operating condition that is responsive and varies depending on a specific current operating condition. A digital display within the gauge includes telltales that are also selectively illuminatable and visually variable, responsive to specific operating conditions to communicate not only a problem or an issue with a specific feature but also a range or magnitude of alert to the vehicle operator.

### BACKGROUND OF THE INVENTION

This disclosure generally relates to instrument cluster features for communicating vehicle operating conditions to a vehicle operator. More particularly, this invention relates to visually variable features of an instrument cluster for communicating vehicle operating parameters.

A vehicle instrument cluster typically includes a plurality of gauges using a pointer to indicate the current value of vehicle operating parameters such as engine rpm, vehicle speed, engine oil pressure, temperature, and many others operating parameters. The gauges provide a simple means of communicating information to an operator of a vehicle. However, reading of any information from the gauges takes the operator's eyes of the road. Further, even though a gauge may include highlighted regions to indicate out of range conditions, the driver is not actively alerted to such out of range conditions.

Accordingly, it is desirable to design and develop a device and method for communicating and alerting a driver of current operating conditions while reducing eyes of the road time.

### SUMMARY OF THE INVENTION

An example disclosed instrument cluster includes a gauge with selectively and visually variable features to communicate vehicle information to a vehicle operator.

The instrument cluster includes a gauge that includes several selectively illuminatable visual indicators. A border is illuminatable by colored LED assemblies to provide an indication of the range of a vehicle operating condition. A pointer assembly is also selectively illuminatable to provide a visual reference of a measured operating condition that is responsive and varies depending on current operating condition. A digital display within the gauge includes telltales that are also selectively illuminatable and visually variable, responsive to specific operating conditions to communicate not only a problem or an issue with a specific feature but also a range or magnitude of alert to the vehicle operator.

Accordingly, the example gauge assembly includes variable visual features that improve communication to the vehicle operator and reduce the eyes off the road time.

These and other features of the present invention can be best understood from the following specification and drawings, the following of which is a brief description.

### BRIEF DESCRIPTION OF THE DRAWINGS

FIG. 1 is a front view of an example vehicle instrument panel.

FIG. 2 is a front view of an example gauge assembly including a selectively illuminated visual indicator.

FIG. 3A is a front view of the example gauge with a selectively illuminated pointer indicating an operating parameter within a first range.

FIG. 3B is a front view of the example gauge with a selectively illuminated pointer indicating an operating parameter within a second range.

FIG. 3C is a front view of the example gauge with a selectively illuminated pointer indicating an operating parameter within a third range.

FIG. 4A is a front view of the example gauge with an illuminated pointer blinking at a first frequency indicative of an operating parameter within the second range.

FIG. 4B is a front view of the example gauge with an illuminated pointer blinking at a first frequency indicative of an operating parameter within the third range.

FIG. 5A is a front view of the example gauge with an illuminated boarder illuminated to indicate an operating parameter within the second range.

FIG. 5B is a front view of the example gauge with an illuminated boarder illuminated to indicate an operating parameter within the third range.

FIG. 6A is a front view of the example gauge with illuminated tell tale indicators in a non-illuminated condition.

FIG. 6B is a front view of the example gauge with illuminated tell tale indicators in an illuminated condition.

FIG. 7 is an example digital display including a tell-tale warning of a door ajar condition.

FIG. 8 is an example digital display including a tell-tale warning of a low fuel condition.

FIG. 9 is an example digital display including a tell-tale warning for a check engine condition.

FIG. 10 is an example digital display including a tell-tale warning of low battery condition.

FIG. 11 is a cross-section of the example digital display.

### DETAILED DESCRIPTION OF THE PREFERRED EMBODIMENT

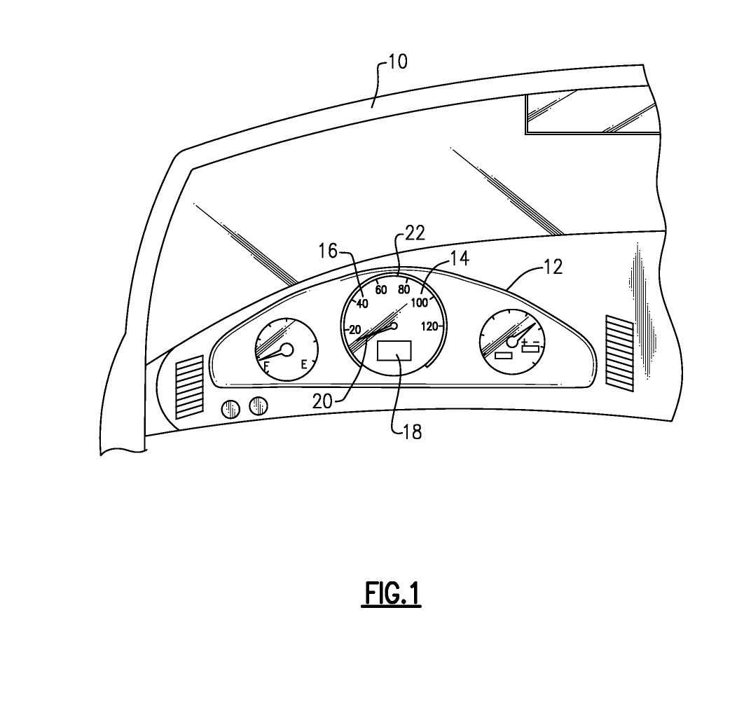

Referring to FIG. 1 an example vehicle 10 includes an instrument cluster 12 for communicating operating information to a vehicle operator. The instrument cluster 12 includes several gauges 14 that provide information regarding certain, specific vehicle operating conditions. For example, one gauge provides an indication of the vehicle fuel level while another provides indication of a coolant temperature. A primary gauge 14 provides an indication of the vehicle speed. The primary gauge 14 includes a scale 16 and a digital display 18. A pointer 20 rotates relative to the scale 16 to indicate current vehicle speed.

The gauge 14 includes a border 22 that is selectively illuminatable to further communicate specific ranges of a selected vehicle operating condition. In this example, the border 22 surrounds the speedometer 14 and can be illuminated in a selective manner to communicate to the driver when the speed is approaching or is in an out of range condition.

As appreciated, although the example gauge 14 relates to a vehicle speedometer other vehicle gauges such as, for example, a tachometer, vehicle temperature gauges, or fuel level gauges will also benefit from the disclosures of this invention.

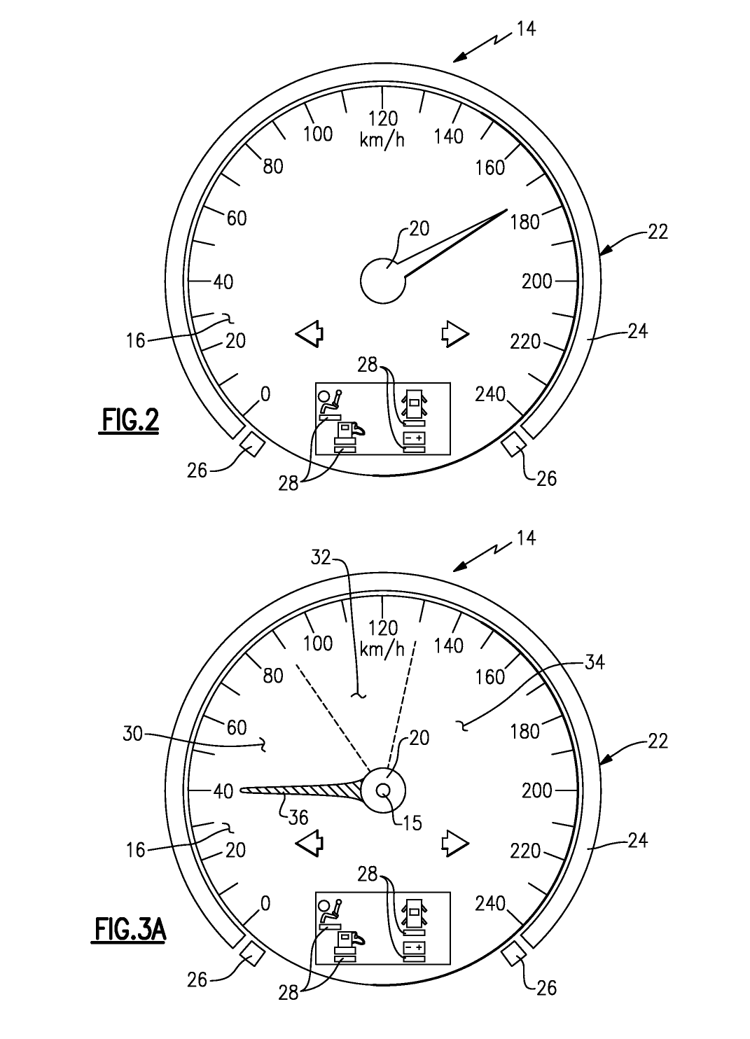

Referring to FIG. 2, the example gauge 14 includes the border 22 that substantially surrounds the gauge 14. The gauge 14 includes the digital display 18 that includes several telltales 28. The telltales 28 are selectively illuminated in a specific color to aid in communicating a condition of the selected vehicle operating parameter.

The border 22 comprises a light guide 24 that substantially surrounds the gate assembly 14 and is illuminated by light-emitting diodes 26. The example light-emitting diodes 26 comprise a cluster of red, green and blue light-emitting diodes (RGB LED). The red, green and blue light-emitting diode assemblies 26 provides for the mixing of colors to obtain an infinite number of desired colors that can be transmitted through the light guide 24.

The example gauge 14 includes several selectively illuminatable visual indicators. In this example, the border 22 is illuminatable by the LED assemblies 26. The pointer assembly 20 is also selectively illuminatable to provide a visual reference of a specific operating condition that is responsive and varies depending on a specific current operating condition. The digital display 18 also includes telltales 28 that are also selectively illuminatable and visually variable, responsive to specific operating conditions to communicate not only a problem or an issue with a specific feature but also a range or magnitude of alert to the vehicle operator.

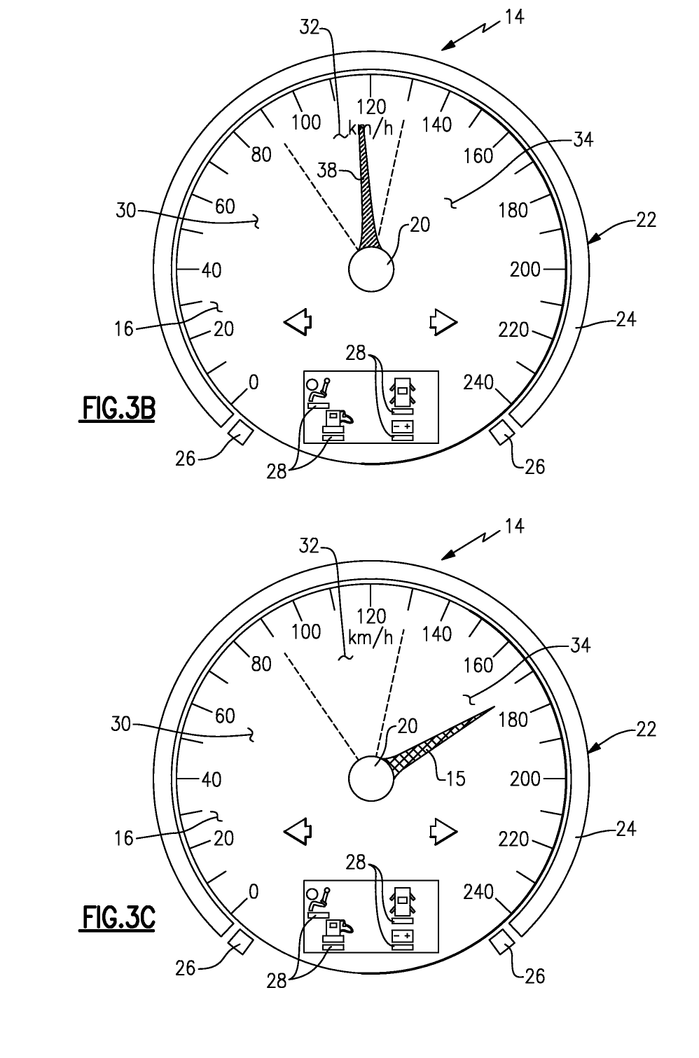

Referring to FIG. 3A, the pointer assembly 20 is selectively illuminatable depending on a specific range of a vehicle operating condition, in this example vehicle speed. The speedometer 14 includes a first range 30, a second range 32 and a third range 34. The specific ranges correspond with the location and road that the vehicle is traveling on. The ranges can vary responsive to the location of the vehicle and the road on which the vehicle is traveling. Such information can be controlled by a vehicle controller using information for a traffic control system, global positioning system, or any other known system that is capable of providing information concerning the current location of the vehicle.

In the example, the first range 30 represents a speed within a posted vehicle speed limit. The example pointer assembly is illuminated in a first color 36 responsive to being within the first range. The first color is illustrated by the shading indicated at 36 along the pointer shaft and can be any desired color, such as for example green to indicate an acceptable range. The color of the pointer 20 may also be varied as desired to coordinate with other aesthetic appointments of the instrument cluster assembly 12.

Referring to FIG. 3B, the pointer 20 is schematically shown illuminated in a second color indicated by the shading 38. The second color is indicative that the vehicle is now operating above or just above certain vehicle operating limits. As appreciated, the second range 32 is indicative of a cautionary range in which the vehicle is operating just above or approaching a limit in vehicle speed.

Referring to FIG. 3C, the example gauge assembly 14 is shown where the vehicle operating conditions are within a third condition that is outside vehicle speed limits. This third range 34 is indicated not only by the pointer position along the scale 16 but also by a third color indicated by shading 40 of the pointer. As appreciated, the pointer colors can vary as is desired. For example, the pointer shading indicating out of range conditions 40 can be red, where the vehicle operating ranges just above or approaching specific limits can be yellow and vehicle parameters within the operating range can show green. However, other colors as would be desired by a vehicle operator to match vehicle ascetics and to provide other communicative features could also be utilized.

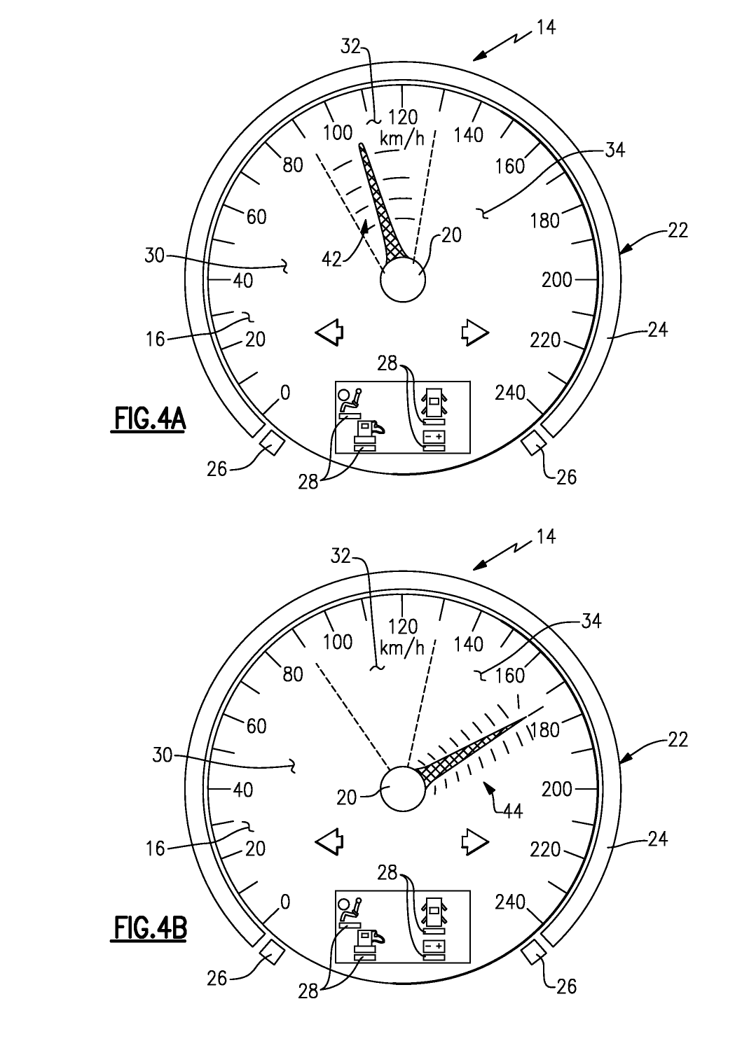

Referring to FIGS. 4A and 4B, another selectively illuminated function is schematically illustrated. In this example, the pointer assembly 20 is selectively illuminated, not by changing colors but by blinking the pointer 20 at a selected frequency.

Referring to FIG. 4A, the pointer 20 is indicating a vehicle operating range within a cautionary second range 32. The blinking pointer provides a visual reference alerting the driver that the vehicle speed is within a cautionary range. The example pointer 20 is schematically shown blinking at a first frequency that is indicative of the vehicle speed being in the cautionary range. The additional visual indication of the blinking pointer 20 provides and communicates to a vehicle operator the out of range condition. As appreciated, it is desirable for a vehicle operator to maintain focus on the road while driving. Time spent examining gauges within the vehicle necessarily takes away from operator focus on the surrounding environment. The example blinking pointer 20 provides an additional visual indication of vehicle speed.

Referring to FIG. 4B, the pointer 20 is shown in a third range 34 that is an out of range condition, where the pointer assembly 20 blinks. The example second frequency is greater or faster than the first frequency 42 to further highlight and alert the operator of the out of range condition. The difference in blinking rates between the first frequency and the second frequency can be adjusted to provide a desired contrast that progressively quickens responsive to vehicle speed.

Referring to FIGS. 5A and 5B, the example gauge assembly 14 includes the lighted border 22. The lighted border 22 can be selectively illuminated to further communicate the position of the current operating condition and range of the operating condition. FIG. 5A illustrates the example pointer 20 within the second cautionary operating range 32 as is indicated by the border 22. Illuminating the border 22 in a first color 46 that is selected to reflect the second range 32 and communicate that range to the operator without the need to examine the gauge assembly 14.

FIG. 5B illustrates a vehicle operating condition where the speed of the vehicle is within a third out of range condition 34. In this condition, the border 22 is at a second color 48. The second color 48 is selected to communicate to the driver that the vehicle is now operating at an over speed condition within the third range 34. As appreciated, the second color 48 could be red or could be other colors to highlight and communicate the specific range that the vehicle is currently operating in.

The first, second and third ranges 30, 32, 34 can be selected according to driver criteria. Further, the ranges 30, 32 and 34 can also be automatically selected and arranged to reflect current and changing vehicle speed limits depending on the position of the vehicle. The border 22 can also be utilized and lighted in a manner to highlight vehicle aesthetics and provide for internal lights to aid in ingress and digress of the vehicle during nighttime conditions.

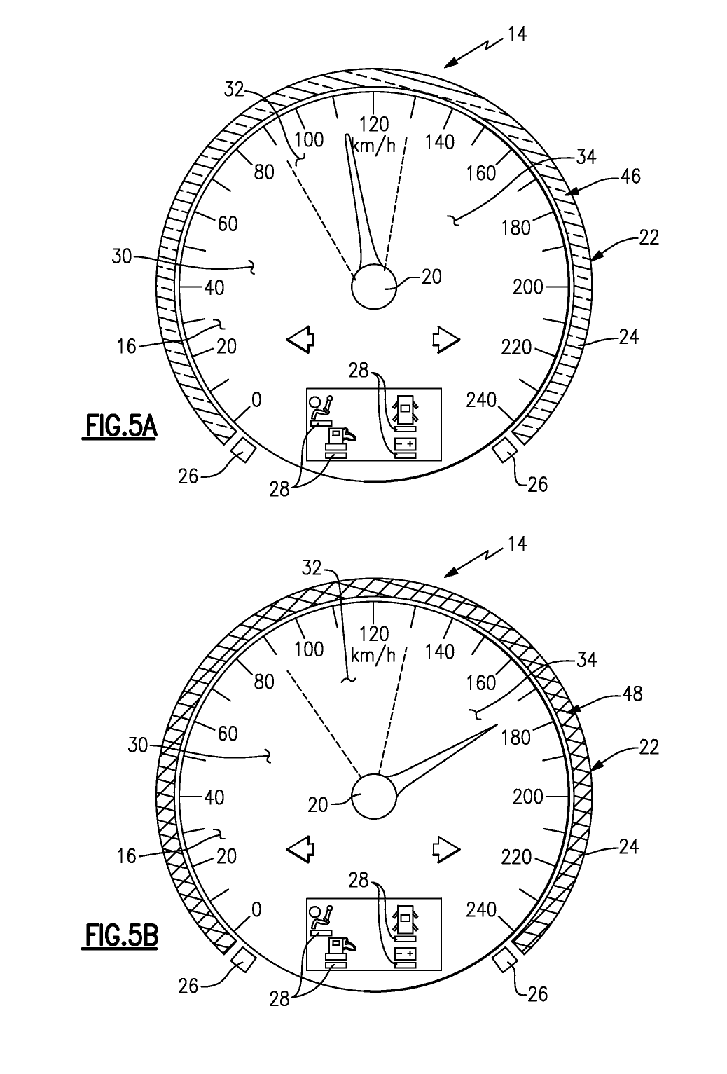

Referring to FIGS. 6A and 6B, the display 18 provides a secondary visual indication of other vehicle operating conditions. Such as, for instance, warning lights that indicate the engine fluid level or temperature is outside of desired conditions. The warning lights are illuminated when an undesired condition is detected. An additional lighted feature is provided in addition to the monochrome color provided by the warning light to better communicate information to the vehicle operator. The on/off warning light as is commonly utilized in such gauge assemblies and does not provide an indication of the severity of the out of range condition. Accordingly, each of the illuminatable warning lights is combined with a selectively illuminatable telltale 28.

In the example gauge assembly 14, the digital display 18 comprises a vacuum fluorescent display that includes a semi-transparent appearance such that each of the warning light symbols is backlit to be visible. The warning light symbol is only in one color and does not provide any indication of the severity of the out of range conditions or the conditions that are attempted to be communicated to the operator. The telltales 28 are selectively illuminated with one of several colors to indicate a severity of the out of range condition.

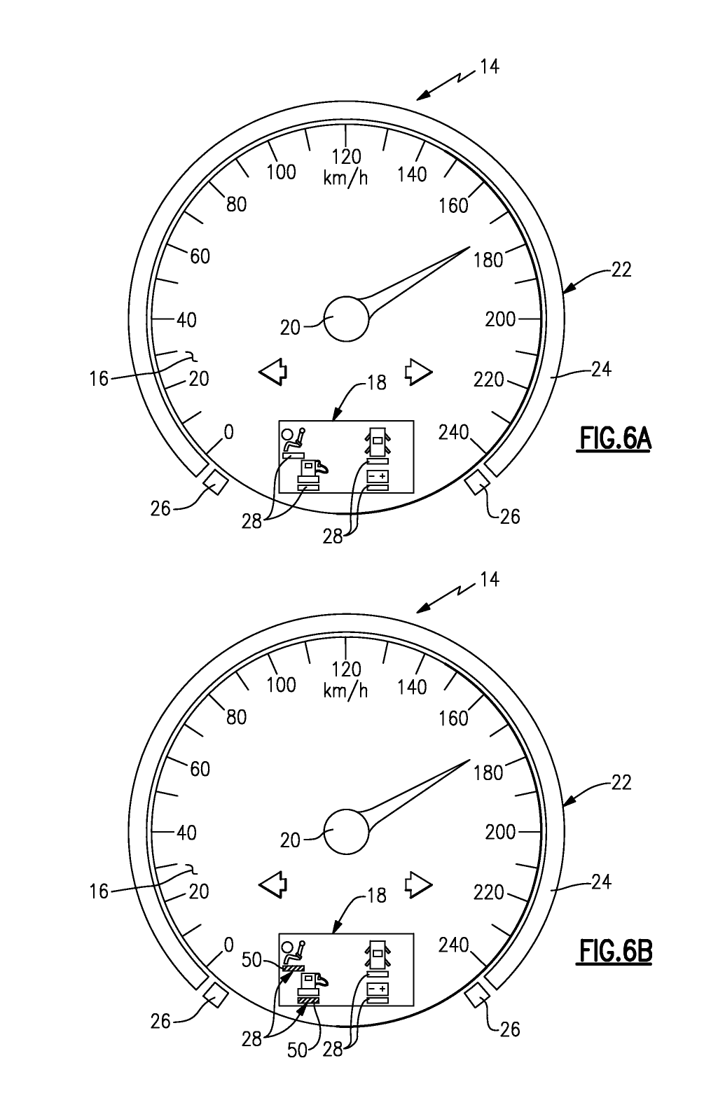

Referring to FIG. 7, the digital display 18 includes a door ajar indication. As appreciated, the door ajar indication is of critical importance as a vehicle should not be operated and driven with the door ajar. Accordingly, the door ajar telltale is illuminated in a first color 52. The example first color 52 is red or some other color that is commonly understood to indicate a condition that requires immediate attention by the operator.

FIG. 8 includes a telltale 54 that is illuminated in response to the fuel level of the vehicle being low. The example fuel level condition is illuminated according to the second color 56. In the example, the second color 56 is yellow or some other color that indicates attention is required but it is not a condition requiring immediate attention. As appreciated, once the fuel level approaches further lower limits, the color of the telltale 54 can be changed to further communicate the increased urgency of the fuel level of the vehicle.

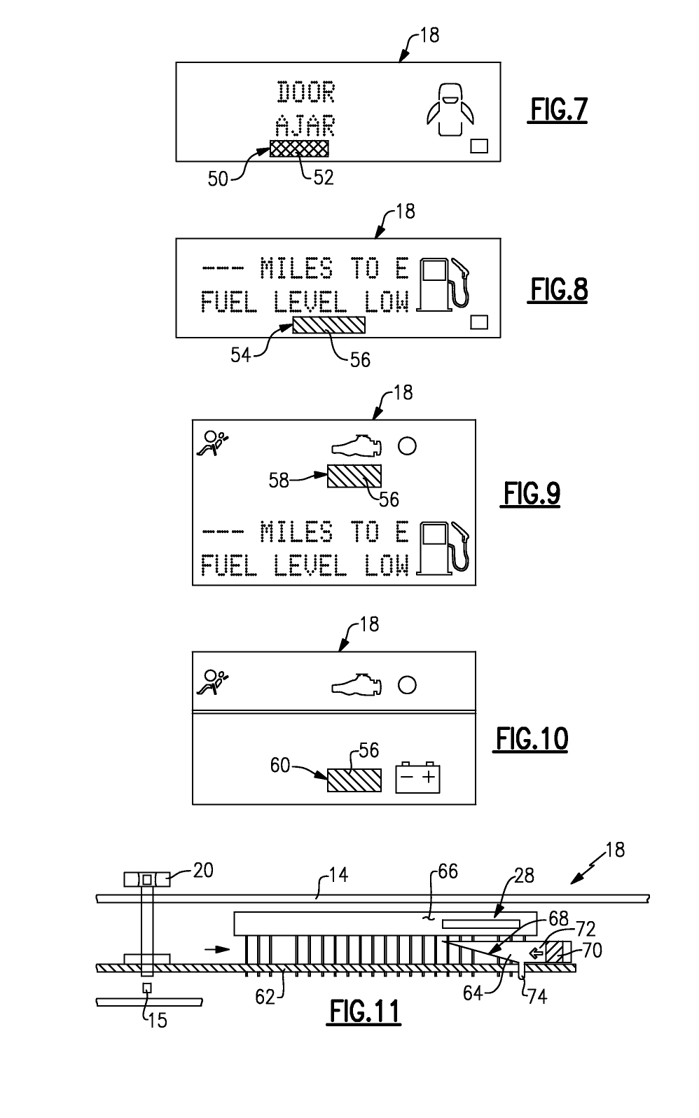

Referring to FIG. 9, the digital display includes a check engine light. As appreciated, check engine light can be illuminated due to many conditions within the vehicle. The telltale 58 is illuminated in a color that aids in bringing attention to the check engine warning light. As appreciated, some conditions merely require that the vehicle be taken to a service station within the near future while other out of range conditions are more critical and require immediate attention by the operator. The telltale 58 is selectively illuminatable in differently colors that would communicate the level of urgency to the operator.

Referring to FIG. 10, another telltale 60 is indicative of battery operating condition and battery health. In this instance, the battery charged capacity can be indicated as the other vehicle operating parameters are to indicate severity and urgency to the operator.

Referring to FIG. 11, the out of range conditions provided in the digital display are illuminated through a vacuum fluorescent display 66. The vacuum fluorescent display 66 provides for the on/off illumination of each of the warning lights. However, the warning lights that are illuminated through the use of the vacuum fluorescent display do not provide the selectively and variable color indications that communicate the severity and urgency of a specific condition.

Illumination of the tell tales 28 is provide through a multi-colored LED assembly 70 that is disposed within a light guide 72. The light guide 72 includes a reflective surface 68. The light guide 64 includes a positioning feature 74 that fits within a printed circuit board 62 to align the reflective surface with the point within the display 66 including the tell tale 28. Illumination of the LED assembly 70 causes light 72 to travel through the light guide 64 and reflect off the reflective surface 68. The reflective light reflects through a portion 28 of the vacuum fluorescent display 76 to provide the desired, colored telltales 28.

Accordingly, the example gauge assembly 14 includes variable visual features that improve communication to the vehicle operator and reduce the eyes of the road time.

As appreciated, the specific examples discussed and illustrated in this disclosure can be combined or utilized on their own. However, each provides a visual indication independent and in addition to the conventional gauges. These indications can vary depending on vehicle operating conditions and location such as, for example, the changing of ranges in response to vehicle operating on roads with different speed limits. Further, all of the visual indicators including the illuminated pointer, illuminated border and specific illuminated telltales in the digital display can be utilized in combination to provide for communication and information for the vehicle operator.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. An instrument cluster assembly comprising:
a gauge including a scale representing a value of an operating parameter; and
a visual indicator associated with a portion of the gauge for indicating a range of the scale, the visual reference varying in appearance responsive to current operating conditions.

2. The assembly as recited in claim 1, wherein the visual indicator comprises a pointer selectively illuminatable responsive to a desired operating condition.

3. The assembly as recited in claim 2, wherein the pointer is selectively illuminatable with a first color light indicating that the desired operating condition is within a first range and with a second color indicating that the desired operating condition is within a second range.

4. The assembly as recited in claim 1, wherein the pointer is illuminated in a blinking manner at a desired frequency responsive to a desired operating condition.

5. The assembly as recited in claim 4, wherein the desired frequency comprises a first frequency indicative of the desired operating condition being within a first range and at least a second frequency indicative of the desired operating condition being within a second range.

6. The assembly as recited in claim 1, wherein the visual indicator comprises a light ring at least partially surrounding the gauge, wherein the light ring is selectively illuminatable responsive to a desired operating condition.

7. The assembly as recited in claim 6, wherein the light ring is illuminatable with a first color responsive to the desired operating condition being within a first range, and with a second color responsive to the desired operating condition being within a second range.

8. The assembly as recited in claim 6, wherein the light ring comprises a border disposed at least partially around the gauge.

9. The assembly as recited in claim 7, wherein the desired operating conditions comprises vehicle speed, and the first range comprises a speed within specified limits, and the second range comprises a speed outside of the specified limits.

10. The assembly as recited in claim 1, wherein the gauge includes a semi-transparent display for communicating information indicative of an operating parameter, the semi-transparent display including a selectively illuminatable tell tale for communicating a range of the operating parameter.

11. The assembly as recited in claim 10, wherein the tell tale is illuminatable in a first color to indicate that the operating parameter is in a first range and is illuminatable in a second color to indicate that the operating parameter is in a second range.

12. A gauge assembly comprising:
a face including a visual reference indicative of an operating condition; and
a visual indicator selectively illuminatable to communicate that the operating condition is within a selected range.

13. The assembly as recited in claim 12, wherein the visual indicator is illuminatable in a first color responsive to the operating condition being in a first range and is illuminatable in at least a second color responsive to the operating condition being in a second range.

14. The assembly as recited in claim 12, wherein the visual indicator is illuminatable at a first frequency responsive to the operating parameter being within a first range and illuminatable in at least a second frequency responsive to the operating parameter being within a second range.

15. The assembly as recited in claim 12, including a tell tale visible on the face of the gauge assembly, wherein the tell tale is illuminatable in at least a first color and a second color responsive to at least one operating condition being within a corresponding first range and a second range.

16. The assembly as recited in claim 12, wherein the visual indicator comprises a portion of a border of the gauge assembly.

17. The assembly as recited in claim 12, wherein the visual indicator comprises a pointer selectively illuminatable responsive to a value of the operating condition.

18. The assembly as recited in claim 17, wherein the pointer is illuminatable according to a first frequency for an operating condition within a first range, and a second frequency for an operating condition within a second range.

19. A method of communicating a measured vehicle parameter comprising the steps of:
determining at least one range of a measured vehicle parameter;
selecting a visual variable illuminatable attribute to indicate a measured value within each of the at least one determined ranges; and
illuminating the visually variable attribute responsive to the measured vehicle parameter being within the at least one range.

20. The method as recited in claim 19, wherein the visually variable attribute comprises a light varying in color responsive to a current condition of the measured vehicle parameter.

21. The method as recited in claim 19, wherein the visually variable attribute comprises blinking a light at a selected frequency associated with the at least one range.

22. The method as recited in claim 19, wherein the visually variable illuminatable attribute comprises illuminating a boarder at least partially surrounding a vehicle gauge.

23. The method as recited in claim 19, wherein the visually variable illuminatable attribute comprises illuminating a pointer in one of at least two colors associated with the at least one range.

24. The method as recited in claim 19, wherein the visually variable illuminatable attribute comprises illuminating a pointer in a blinking manner at a frequency associated with each of the at least one range.

25. The method as recited in claim 19, wherein the visually variable illuminatable attribute comprises a telltale associated with a warning light that is illuminatable to reflect at least two different conditions of a measured vehicle parameter.
